(19) United States
(12) Patent Application Publication
(10) Pub. No.: US 2016/0363271 A1
(43) Pub. Date: Dec. 15, 2016

(54) SOLID-FILLED ENCAPSULATED LED BULB

(71) Applicant: UNITY OPTO TECHNOLOGY CO., LTD., New Taipei City (TW)

(72) Inventors: CHIH-HSIEN WU, NEW TAIPEI CITY (TW); SEN-YUH TSAI, NEW TAIPEI CITY (TW); CHUN-CHIEH HUANG, NEW TAIPEI CITY (TW); YU-CHANG CHEN, NEW TAIPEI CITY (TW)

(21) Appl. No.: 14/844,308

(22) Filed: Sep. 3, 2015

(30) Foreign Application Priority Data
Jun. 11, 2015 (TW) 104118870

(51) Int. Cl. F21K 99/00; F21V 23/02; F21V 3/04; F21V 29/70

(52) U.S. Cl. CPC F21K 9/52; F21V 29/70; F21V 23/023; F21V 3/0463; F21Y 2101/02; F21V 2200/30

(57) ABSTRACT

A solid-filled encapsulated LED bulb with a base, at least one LED light source and at least one power supply element includes a transparent solid-filled heat-dissipating light guide member attached and covered onto the LED light source and the power supply element. A side of the heat-dissipating light guide member is packaged with the base to form the LED bulb. The heat of the LED light source is conducted and dissipated to the outside through the heat-dissipating light guide member. A light of the LED light source is outputted with an intensity I_{A} through the heat-dissipating light guide member. The intensity I_{A} of the light and the intensity IB of the LED light source satisfy the condition of (I_{A}/I_{B})>70%. The use of a conventional dissipating structure is skipped to reduce the production cost and expedite the assembling and packaging processes while maintaining excellent heat dissipation and light output effects.

### CROSS-REFERENCE TO RELATED APPLICATIONS

This non-provisional application claims priority under 35 U.S.C. §119(a) on Patent Application No(s). 104118870 filed in Taiwan, R.O.C. on Jun. 11, 2015, the entire contents of which are hereby incorporated by reference.

### BACKGROUND OF THE INVENTION

1. Field of the Invention

The technical field relates to light bulbs, and more particularly to a solid-filled encapsulated LED bulb having a solid-filled heat-dissipating light guide body covered onto an LED light source and being packaged directly with a base

2. Description of the Related Art

As science and technology advance, and environmental protection and illumination requirements become increasingly higher and more diversified, bulbs have been developed from the early incandescent bulbs to those using LED as a light emitting source, so as to enhance the functionality and convenience of the bulbs.

With reference to FIG. 1 for a conventional LED bulb, the conventional LED bulb 1 comprises a base 10, a power supply 11, at least one LED light source 12 and a lamp cover 13. The base 10 is provided for installing the power supply 11, and the LED light source 12 is generally installed at the top surface of the base 10 and electrically connected to the power supply 11, and the lamp cover 13 is provided for covering the base 10 and engaging the base 10 to seal the LED light source 12 therein. Although LED has the advantages of power saving, small volume and high color rendering, the design of an LED bulb needs to take the heat dissipation issue into consideration in order to prevent damaging the LED or shortening the life of the LED by accumulated high heat after a long time of use. Therefore, the conventional LED bulb 1 generally requires an additional heat dissipating structure 14. Most of the heat dissipating structures 14 are made of metal with a high thermal conductivity and integrally formed with the base 10 for effectively dissipating the heat generated during the operation of the LED light source 12. The heat dissipating structures 14 are arranged around the external periphery of the base 10 or connected to the top side of the base 10, an the heat dissipating structures 14 are in the form of surrounding fins for conducting the heat of the LED light source 12.

From the description above, the conventional LED bulb 1 needs the heat dissipating structure to overcome the overheat issue of the LED light source 12 during the operation of the LED bulb 1. At present, such structural design cannot be skipped in the industry of the LED bulb, and most manufacturers spare no effort to improve the heat dissipating structure 14 by reducing the occupied volume or enhancing the heat dissipating effect. Compared with the early incandescent bulbs, the conventional LED bulb 1 has the features of saving energy and giving a good color expression, but it also requires the additional heat dissipating structure 14, and thus incurring higher manufacturing, assembling and design costs.

To overcome the heat dissipation issue of the LED bulb while lowering the manufacturing cost, some manufacturers use a liquid as a thermal conductor to improve the heat dissipating effect of the conventional LED bulb 1 and further skip the use of the heat dissipating structure 14, wherein heat conduction is totally relied on the liquid. In FIG. 2, the lamp cover 13 is filled with a liquid 15, on that the liquid 15 is in contact with the LED light source 12 to achieve the effect of conducting heat for autologous heat dissipation. Although the method of filling the liquid 15 into the lamp cover 13 can skip the installation of the heat dissipating structure 14, it is difficult for the manufacturers to seal the lamp cover 13 with the base 10 since the liquid 15 is filled up in the lamp cover 13. Therefore, a perfect sealing effect between the lamp cover 13 and the base 10 must be achieved to prevent the liquid 15 from leaking, or else the bulb may be damaged or malfunctioned, or the liquid 15 may be leaked during the use of the LED bulb. The aforementioned issue is a difficult issue for related manufacturers to overcome, and it also increases the level of difficulty of the packaging and manufacturing processes and lowers the yield rate of the conventional LED bulb 1.

Therefore, the inventor of this disclosure discloses a solid-filled encapsulated LED bulb to simplify the manufacturing process and reduce the cost of the LED bulb while maintaining a very good heat dissipation performance.

### SUMMARY OF THE INVENTION

In view of the problems of the prior art, it is a primary objective of this disclosure to provide a solid-filled encapsulated LED bulb with the effects of waiving the heat dissipating structure of the conventional bulb, simplifying the assembling, packaging and manufacturing processes, and reducing the manufacturing time of the bulb to achieve a quick packaging and production effect, whole maintaining excellent heat dissipating effect and light output effect.

To achieve the aforementioned and other objectives, this disclosure provides a solid-filled encapsulated LED bulb comprising a base, at least one LED light source and at least one power supply element, characterized in that the solid-filled encapsulated LED bulb further comprises a heat-dissipating light guide member, being a transparent solid structure tightly attached and covered onto the LED light source and the power supply element, and a side of the heat-dissipating light guide member is sealed with the base to form the solid-filled encapsulated LED bulb; wherein the heat-dissipating light guide member is in contact with the LED light source to conduct and dissipate heat from the LED light source, and a light of the LED light source is outputted with a light intensity IA from the heat-dissipating light guide member and the light intensity IA and a light intensity 1B of the LED light source satisfy the condition of (IA/IB)>70%.

In the aforementioned embodiment, the heat-dissipating light guide member and the LED light source and the power supply element are integrally formed by an injection molding method or a casting molding method, so that the heat-dissipating light guide member is closely attached to the LED light source and the power supply element, and during a injection molding or casting molding process, the heat-dissipating light guide member and the LED light source and the power supply element covered by the heat-dissipating light guide member is packaged directly with the base to form the solid-filled encapsulated LED bulb. Therefore, the required packaging and manufacturing time of the LED bulb can be reduced to lower the manufacturing cost and enhance the convenience of the assembling process.

Wherein, the LED light source the LED light source comes with a plural quantity, and the LED light sources are arranged into a circular shape, an arc shape, or a polygonal shape, so that the heat of the LED light sources is distributed uniformly to meet the requirements for the light output of various types of bulbs. To facilitate the assembling process, the power supply element and the LED light source are combined into an integral structure to skip the electric circuit of the power supply element and the LED light source. In the meantime, the heat-dissipating light guide member can be in contact with the LED light source and the power supply element more closely. The power supply element may come with a singular quantity for connecting each of the LED light sources, or comes with a quantity corresponsive to the quantity of the LED light sources for connecting the LED light sources to the power supply elements respectively.

The heat-dissipating light guide member is selectively made of glass, plastic and resin. To further enhance the light uniformity of the solid-filled encapsulated LED bulb, at least one optical pattern is formed on a surface of the heat-dissipating light guide member, or the heat-dissipating light guide member is doped with at least one uniform luminous material to enhance the overall light uniformity of the heat-dissipating light guide member.

This disclosure further discloses a solid-filled encapsulated LED bulb with comprising a base, at least one LED light source and at least one power supply element, and the solid-filled encapsulated LED bulb further comprising: a heat-dissipating light guide member, being a transparent solid structure tightly and having at least one mounting slot for installing the LED light source and the power supply element, and a side of the heat-dissipating light guide member being packaged with the base to form the solid-filled encapsulated LED bulb, and a light of the LED light source being outputted with a light intensity IA from the heat-dissipating light guide member and the light intensity IA and a light intensity IB of the LED light source satisfying the condition of (IA/IB)>70%; and at least one light permeable plastic, filled into the mounting slot for fixing the LED light source and the power supply element, wherein the heat-dissipating light guide member is in contact with the LED light source through the light permeable plastic to conduct and dissipate heat from the LED light source.

Wherein, the mounting slot comes with a plural quantity, and the mounting slots are arranged in a circular shape, an arc shape or a polygonal shape, and the quantity of the LED light sources is corresponsive to the quantity of the mounting slots. Therefore, the heat of the heat-dissipating light guide member is distributed more uniformly, so as to further meet different light output requirements. To simplify the manufacturing process, the power supply element and the LED light source are combined to form an integral structure.

The heat-dissipating light guide member is made of glass or plastic, and at least one optical pattern is formed on a surface of the heat-dissipating light guide member to enhance the light uniformity of the heat-dissipating light guide member, or the heat-dissipating light guide member is doped with at least one uniform luminous material for enhancing the light uniformity.

In summation of the description above, the solid-filled encapsulated LED bulb of this disclosure has a solid-filled heat-dissipating light guide member covered onto and contacted with the LED light source to conduct the heat of the LED light source to the outside while guiding the light to the outside, so as to achieve the effects of guiding light and dissipating heat at the same time. In addition, the heat-dissipating light guide member is packaged directly with the base to form the bulb, so as to reduce the number and the type of components of the bulb to lower the production cost effectively and improve the manufacturing speed and the production rate significantly.

### BRIEF DESCRIPTION OF THE DRAWINGS

FIG. 1 is a perspective view of a conventional bulb;

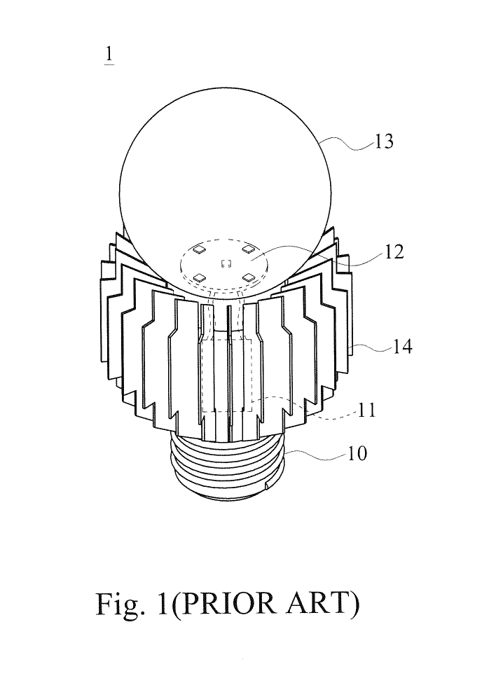

FIG. 2 is a perspective view of another implementation mode of the conventional bulb;

FIG. 3 is an exploded view of a first exemplary embodiment of this disclosure;

FIG. 4 is a schematic view of an assembly of the first exemplary embodiment of this disclosure;

FIG. 5 is a cross-sectional view of the first exemplary embodiment of this disclosure;

FIG. 6 is a cross-sectional view of another implementation mode of an assembly of the first exemplary embodiment of this disclosure;

FIG. 7 is an exploded view of a second exemplary embodiment of this disclosure;

FIG. 8 is a schematic view of an assembly of the second exemplary embodiment of this disclosure; and

FIG. 9 is a cross-sectional view of the second exemplary embodiment of this disclosure.

### DESCRIPTION OF THE PREFERRED EMBODIMENTS

The technical content of this disclosure will become apparent with the detailed description of preferred embodiments and the illustration of related drawings as follows.

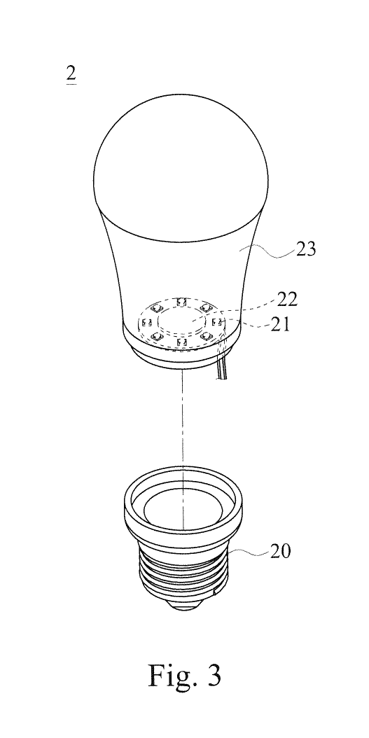

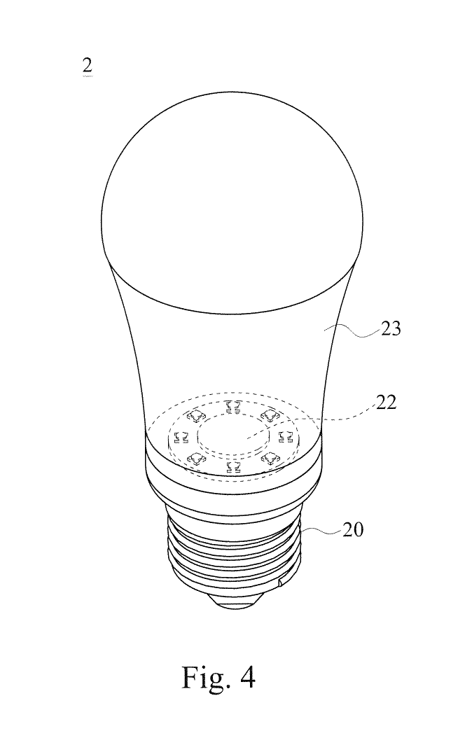

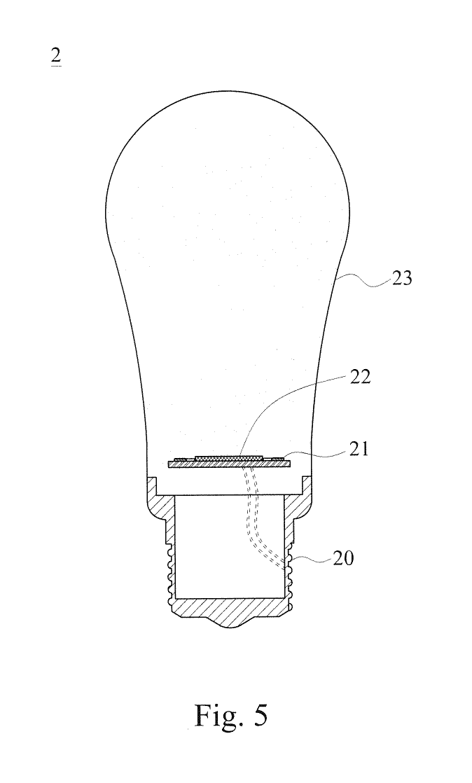

With reference to FIGS. 3, 4 and 5 for an exploded view, a schematic view and a cross-sectional view of the first exemplary embodiment of a solid-filled encapsulated LED bulb of this disclosure, the solid-filled encapsulated LED bulb 2 comprises a base 20, at least one LED light source 21 and at least one power supply element 22. Wherein, the base 20 is provided for electrically connecting an external power supply and supplying electric power to the solid-filled encapsulated LED bulb 2.

The solid-filled encapsulated LED bulb 2 is characterized in that it has a heat-dissipating light guide member 23 which is a transparent solid-filled structure closely attached and covered onto the LED light source 21 and the power supply element 22, and a side of the heat-dissipating light guide member 23 is packaged with the base 20 to form the solid-filled encapsulated LED bulb 2. Preferably, the heat-dissipating light guide member 23 is made of glass or plastic (such as epoxy resin or resin). Wherein, the heat-dissipating light guide member 23 is provided for dissipating heat of the LED light source 21 to the outside, while projecting the light of the LED light source 21 to the outside. Since the heat-dissipating light guide member 23 is closely attached and covered onto the LED light source 21 and the power supply element 22, so that the heat-dissipating light guide member 23 guides the heat of the LED light source 21 to the outside by conduction, and a light of the LED light source 21 is outputted with a light intensity IA from the heat-dissipating light guide member 23, wherein the light intensity IA of the light outputted from the heat-dissipating light guide member 23 and the light intensity 1B of the LED light source 21 satisfy the condition of (IA/IB)>70%. Therefore, the LED bulb of this disclosure has excellent light transmittance.

Unlike the conventional bulb, the solid-filled encapsulated LED bulb 2 of this disclosure adopts the aforementioned structure to simplify the packaging and manufacturing process and lower the production cost of the LED bulb and limits the heat-dissipating light guide member 23 to a solid-filled form, so that the heat conduction through the solid can overcome the heat dissipating issue of the LED light source 21. Since the heat-dissipating light guide member 23 is in a solid state and closely attached with the LED light source 21 and the power supply element 22, therefore the heat generated during the operation of the LED light source 21 can be conducted directly through the heat-dissipating light guide member 23 to achieve a full-range heat dissipating effect. Although the heat-dissipating light guide member 23 is in a solid form, it still can guide and output the light of the LED light source 21 effectively and maintain a high transmittance of (IA/IB)>70% to prevent affecting the light output performance of the LED light source 21 by the thickness of the heat-dissipating light guide member 23.

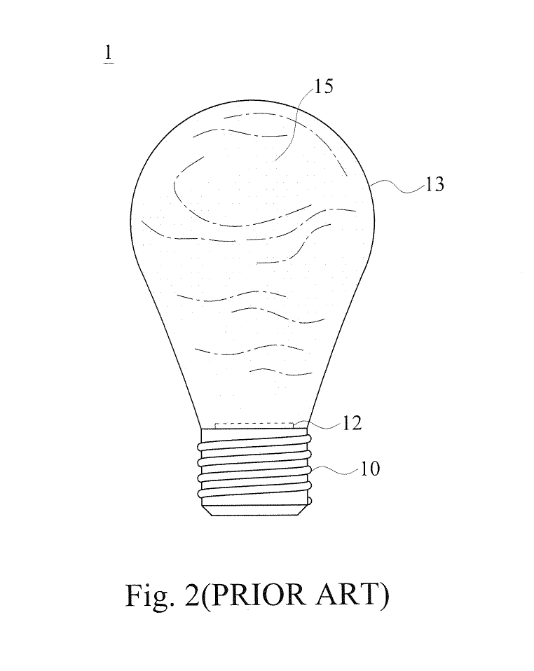

It is noteworthy that the heat-dissipating light guide member 23 and the LED light source 21 and the power supply element 22 are integrally formed by injection molding or casting molding, so that the heat-dissipating light guide member 23 is closely attached to the LED light source 21 and the power supply element 22. In the injection molding or casting molding process, the heat-dissipating light guide member 23 and the LED light source 21 and the power supply element 22 covered by the heat-dissipating light guide member 23 are packaged directly with the base 20 to form the solid-filled encapsulated LED bulb 2. In other words, the base 2 is put into a mold core and on a side corresponsive to a molding area of the heat-dissipating light guide member 23 during the injection molding process, and the LED light source 21 and the power supply element 22 are put into the mold core and within the molding area of the heat-dissipating light guide member 23, and then a cast material of the heat-dissipating light guide member 23 is filled, such that when the heat-dissipating light guide member 23 is injected, the LED light source 21 and the power supply element 22 are covered therein, while being packaged with the base 20. It is noteworthy that the base 20 and the heat-dissipating light guide member 23 are separated as shown in FIG. 2 for simplicity.

Therefore, the covered contact area of the LED light source 21 with the power supply element 22 and the heat-dissipating light guide member 23 can be maximized, and the solid-filled encapsulated LED bulb 2 can be manufactured in a single process to simplify the required manufacturing time and reduce the level of difficulty of the manufacturing process, so as to improve the production efficiency significantly. To facilitate the application of this disclosure and the assembling and packaging methods, the LED light source 21 and the power supply element 22 may be combined into an integral structure to skip the process of connecting the LED light source 21 with the power supply element 22 by an electric circuit and reduce the volume occupied by the electronic components in the solid-filled encapsulated LED bulb 2, so as to achieve the effects of improving the integrity of forming the heat-dissipating light guide member 23 and making the manufacturing process much easier.

In the solid-filled encapsulated LED bulb 2 of this disclosure, the LED light source 21 may be a planar light source or a three-dimensional light source, and may come with a plural quantity. For a plurality of LED light sources 21, the LED light sources 21 may be arranged in a circular shape, an arc shape, or a polygonal shape, so that the heat of the LED light sources 21 can be distributed uniformly. In this embodiment, the LED light sources 21 are planar light sources arranged in a circular shape. Preferably, the LED light sources 21 are arranged in a light panel. In addition, the power supply element 22 comes with a singular quantity and the power supply element 22 is connected to each of the LED light sources 21 to form an integral structure, or the power supply element 22 comes with a quantity corresponsive to the quantity of the LED light sources 21, so that each of the LED light sources 21 and the power supply element 22 are connected as a whole. In this embodiment, there is one power supply element 22.

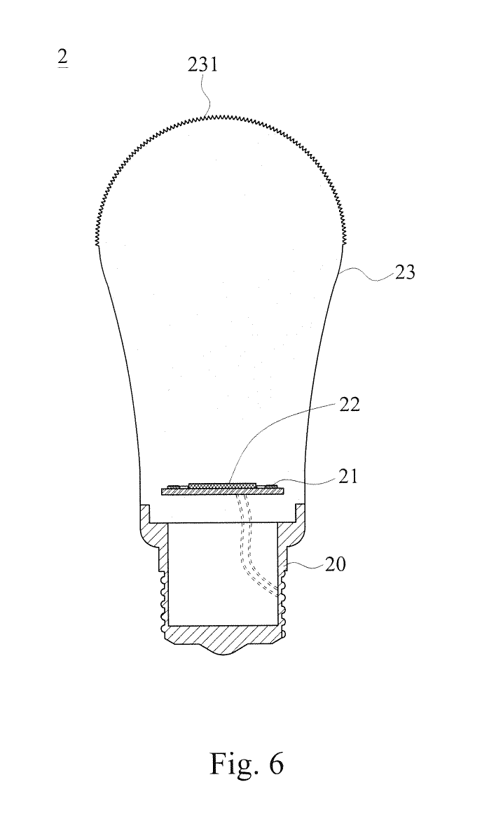

With reference to FIG. 6 for a cross-sectional view of another implementation mode of an assembly of the first exemplary embodiment of this disclosure, at least one optical pattern 231 is formed on a surface of the heat-dissipating light guide member 23 to provide a more uniform light output effect of the solid-filled encapsulated LED bulb 2. Wherein, the optical pattern 231 is configured in the light output direction of the LED light sources 21, and the optical pattern 231 may be composed of a plurality of tiny concave holes or convex tablets, so that the uniformity of the light of the LED light sources 21 projected through the concave holes or the convex tablets to an outer side of the heat-dissipating light guide member 23 can be improved. In another method, the heat-dissipating light guide member 23 is doped with at least one uniform luminous material, so that the uniformity of the light of the LED light sources 21 projected to the outside can be improved by the uniform luminous material. The uniform luminous material is able to make the directional light of the LED light sources 21 into a diffusion mode, so as to enhance the overall uniformity and softness of the outputted light, and also increase the illumination angle of the solid-filled encapsulated LED bulb 2. In this implementation mode, the heat-dissipating light guide member 23 has the optical pattern 231.

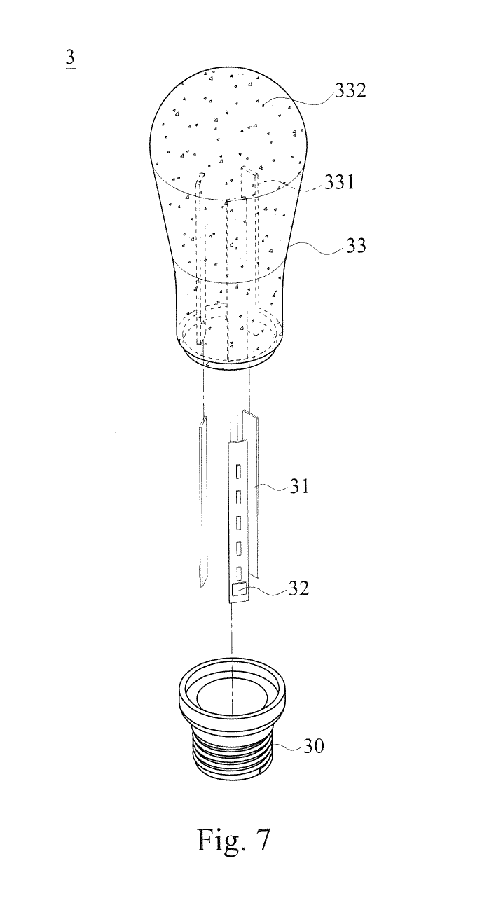

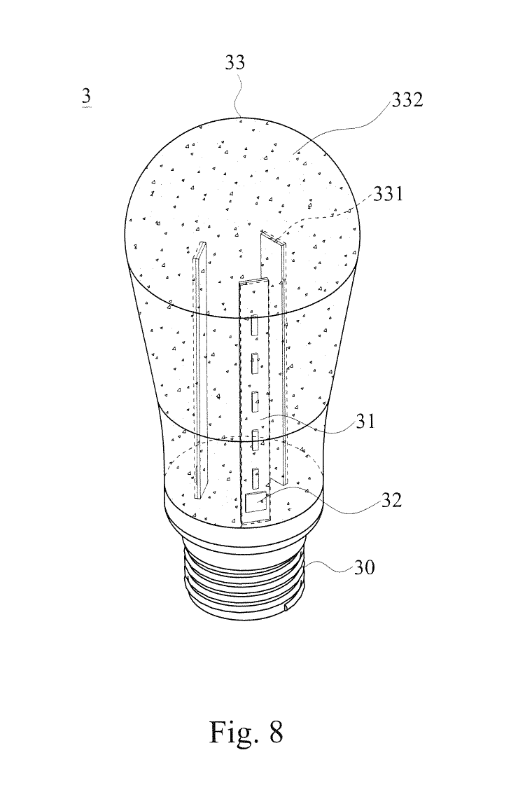

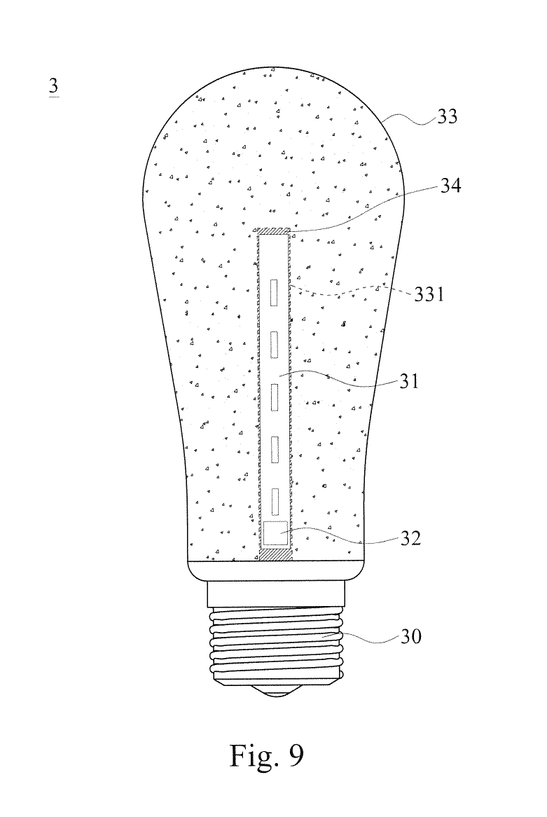

With reference to FIGS. 7, 8 and 9 for an exploded view, a schematic view, and a cross-sectional view of a second exemplary embodiment of a solid-filled encapsulated LED bulb 3 of this disclosure, the solid-filled encapsulated LED bulb 3 comprises a base 30, at least one LED light source 31 and at least one power supply element 32. The solid-filled encapsulated LED bulb 3 further comprises a heat-dissipating light guide member 33 and at least one light permeable plastic 34.

The heat-dissipating light guide member 33 is a transparent solid-filled structure and has at least one mounting slot 331 for installing the LED light source 31 and the power supply element 32. A side of the heat-dissipating light guide member 33 packaged with the base 30 to form the solid-filled encapsulated LED bulb 3, and a light of the LED light source 31 is outputted from the heat-dissipating light guide member 33 with an intensity IA, and the light intensity IA outputted from the heat-dissipating light guide member 33 and the light intensity IB of the LED light source 31 satisfy the condition of (1A/IB)>70%. Even if the heat-dissipating light guide member 33 is in a solid-filled mode, the aforementioned excellent light transmittance can be maintained, and the light emission performance of the solid-filled encapsulated LED bulb 3 will not be affected by the thickness of the heat-dissipating light guide member 33.

The light permeable plastic 34 is filled into the mounting slot 331 for fixing the LED light source 31 with the power supply element 32, wherein the heat-dissipating light guide member 33 conducts and dissipates the heat generated by the LED light source 31 to the outside through the light permeable plastic 34, so that the conventional heat dissipating structure can be skipped while maintaining a full-range heat dissipating effect.

Wherein, the mounting slot 331 comes with a plural quantity, and the mounting slots 331 are arranged into a circular shape, an arc shape or a polygonal shape, and the quantity of the LED light sources 31 is corresponsive to the quantity of the mounting slots 331. Preferably, the LED light sources 31 are arranged on a light panel, so that the light output angle and the heat distribution of the LED light sources 31 may be adjusted conveniently. In this embodiment, there are three mounting slots 331 and arranged in a substantially triangular shape, and the LED light sources 31 are arranged vertically to form a three-dimensional light source, so that the projection direction of the light is from an edge of the heat-dissipating light guide member 33 to the outside.

In addition, the power supply element 32 and the LED light source 31 are combined into an integral structure to facilitate their installation in the mounting slot 331, and the light permeable plastic 34 is filled and fixed therein. The heat-dissipating light guide member 33 may be made of glass, plastic or resin and manufactured by an injection molding or casting molding method according to the specification of the solid-filled encapsulated LED bulb 3. Similar to the first exemplary embodiment, at least one optical pattern is formed on a surface of the heat-dissipating light guide member 33 or the heat-dissipating light guide member 33 is doped with at least one uniform luminous material 332 to improve the light uniformity, so that the light path of the projected light of the LED light sources 31 may be adjusted by the optical pattern or the particles of the uniform luminous material 332. As a result, the light projected from the heat-dissipating light guide member 33 is more uniform. In this embodiment, the heat-dissipating light guide member 33 is doped with the uniform luminous material 332.

In summation of the description above, the solid-filled encapsulated LED bulb has the solid-filled heat-dissipating light guide member covered directly onto the LED light source and the power supply element, and the heat generated during the operation of the LED light source is dissipated to the outside by the solid-filled thermal conduction. Since the heat-dissipating light guide member is solid, a better heat dissipation can be achieved. In addition, the heat-dissipating light guide member is packaged directly with the base to reduce the quantity of components of the conventional bulb and improve the production efficiency by simplifying the assembling and manufacturing processes. The LED bulb of this disclosure also provides excellent thermal conductivity and light output effect. In addition, the heat-dissipating light guide member is integrally formed with the LED light source and the power supply element in the injecting molding process and also packaged directly with the base to form the solid-filled encapsulated LED bulb. Further, the heat-dissipating light guide member has the mounting slot for installing the LED light source and the power supply element and then filling the light permeable plastic to seal them. In addition, the LED light source and the power supply element are combined into an integral structure, so that the integral structure of the LED light source and the power supply element may be placed at a predetermined position for combining with the heat-dissipating light guide member to perform the injection molding. Therefore, the step of connecting the LED light source with the power supply element by an electric circuit may be skipped, so as to prevent affecting the tight attachment between the heat-dissipating light guide member and the LED components and the power supply elements.

What is claimed is:

1. A solid-filled encapsulated LED bulb, comprising a base, at least one LED light source and at least one power supply element, characterized in that the solid-filled encapsulated LED bulb further comprises a heat-dissipating light guide member, being a transparent solid structure tightly attached and covered onto the LED light source and the power supply element, and a side of the heat-dissipating light guide member is sealed with the base to form the solid-filled encapsulated LED bulb; wherein the heat-dissipating light guide member is in contact with the LED light source to conduct and dissipate heat from the LED light source, and a light of the LED light source is outputted with a light intensity I_{A} from the heat-dissipating light guide member and the light intensity I_{A} and a light intensity I_{B} of the LED light source satisfy the condition of (I_{A}/I_{B})>70%.

2. The solid-filled encapsulated LED bulb as claimed in claim 1, wherein the heat-dissipating light guide member and the LED light source and the power supply element are integrally formed by an injection molding method or a casting molding method, so that the heat-dissipating light guide member is closely attached to the LED light source and the power supply element, and during an injection molding or casting molding process, the heat-dissipating light guide member and the LED light source and the power supply element covered by the heat-dissipating light guide member is packaged directly with the base to form the solid-filled encapsulated LED bulb.

3. The solid-filled encapsulated LED bulb as claimed in claim 2, wherein the LED light source comes with a plural quantity, and the LED light sources are arranged into a circular shape, an arc shape, or a polygonal shape.

4. The solid-filled encapsulated LED bulb as claimed in claim 3, wherein the power supply element and the LED light source form an integral structure.

5. The solid-filled encapsulated LED bulb as claimed in claim 4, wherein the power supply element comes with a singular quantity for connecting each of the LED light sources, or comes with a quantity corresponsive to the quantity of the LED light sources for connecting the LED light sources to the power supply elements respectively.

6. The solid-filled encapsulated LED bulb as claimed in claim 5, wherein the heat-dissipating light guide member is made of glass, plastic or resin.

7. The solid-filled encapsulated LED bulb as claimed in claim 1, wherein the heat-dissipating light guide member surface has at least one optical pattern for enhancing the light uniformity of the heat-dissipating light guide member.

8. The solid-filled encapsulated LED bulb as claimed in claim 1, wherein the heat-dissipating light guide member is doped with at least one uniform luminous material for enhancing the light uniformity.

9. A solid-filled encapsulated LED bulb, comprising a base, at least one LED light source and at least one power supply element, and the solid-filled encapsulated LED bulb further comprising:
a heat-dissipating light guide member, being a transparent solid structure and having at least one mounting slot for installing the LED light source and the power supply element, and a side of the heat-dissipating light guide member being packaged with the base to form the solid-filled encapsulated LED bulb, and a light of the LED light source being outputted with a light intensity I_{A} from the heat-dissipating light guide member and the light intensity I_{A} and a light intensity I_{B} of the LED light source satisfying the condition of (I_{A}/I_{B})>70%; and at least one light permeable plastic, filled into the mounting slot for fixing the LED light source and the power supply element, wherein the heat-dissipating light guide member is in contact with the LED light source through the light permeable plastic to conduct and dissipate heat from the LED light source.

10. The solid-filled encapsulated LED bulb as claimed in claim 9, wherein the mounting slot comes with a plural quantity, and the mounting slots are arranged in a circular shape, an arc shape or a polygonal shape, and the quantity of the LED light sources is corresponsive to the quantity of the mounting slots.

11. The solid-filled encapsulated LED bulb as claimed in claim 10, wherein the power supply element and the LED light source form an integral structure.

12. The solid-filled encapsulated LED bulb as claimed in claim 11, wherein the heat-dissipating light guide member is made of glass, plastic or resin.

13. The solid-filled encapsulated LED bulb as claimed in claim 9, wherein the heat-dissipating light guide member surface has at least one optical pattern for enhancing the light uniformity of the heat-dissipating light guide member.

14. The solid-filled encapsulated LED bulb as claimed in claim 9, wherein the heat-dissipating light guide member is doped with at least one uniform luminous material for enhancing the light uniformity.
